(19) United States
(12) Patent Application Publication
(10) Pub. No.: US 2009/0049394 A1
(43) Pub. Date: Feb. 19, 2009

(54) QUANTIFYING AND ANALYZING BACK OFFICE AND FIELD SERVICE PROCESSES

(75) Inventor: John A. RICKETTS, Clarendon Hills, IL (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 11/840,121

(22) Filed: Aug. 16, 2007

(51) Int. Cl. G06F 17/30; G06F 3/048

(52) U.S. Cl. 715/765; 707/104.1; 707/E17.009

(57) ABSTRACT

A method includes collecting quantifying data to quantify each activity of a process, consolidating the quantifying data into a process record in a central location, and creating a process view from the process record. The process view includes at least an indication of a timing and duration of each activity of the process.

### FIELD OF THE INVENTION

The present invention relates to a method and system for quantifying and analyzing back office processes (BOP) and field service processes (FSP) in order to support capacity management, process improvement, and/or service level attainment.

### BACKGROUND OF THE INVENTION

Recently, there has been a growth in managed business process services, wherein a service provider provides services on behalf of clients, or uses information technology (IT) on behalf of clients. For example, many entities (e.g., companies) are not in the business of accounting (e.g., a toy manufacturer); nonetheless, such entities may require an accounting department to handle their internal accounting needs. However, running the accounting department internally may detract from those entities (e.g., a toy manufacturer) performing their core business processes. That is, as such entities may not be experts in, e.g., accounting, it may be inefficient for them to run an internal accounting department. Moreover, running the accounting department may be expensive for an individual entity.

However, utilizing managed business process services (e.g., to perform the accounting processes) may allow an entity (e.g. a business) to focus on their core business. Moreover, by utilizing economies of scale, the managed business process service providers may be able to perform the same business process services (e.g., accounting) at lower costs. That is, a service provider may provide a service (e.g., accounting) for many entities with reduced overhead, and thus, with reduced costs to each individual entity. These managed business process services may include back office processes (BOP), field service processes (FSP) and front office processes (FOP).

A BOP may be performed in an office or service center, usually with little or no direct contact with service recipients, because the necessary inputs are already available. Examples of BOPs include payroll, accounting, procurement, and underwriting. Additionally, a BOP may be a manual process, an automated process, or a mix thereof. For example, the majority of BOPs may be processed automatically, with exceptions handled manually.

An FSP may generally be performed at service recipients' sites (or hosting sites); hence the name “field service”. An FSP may be required when a process is complex (e.g., replacing a faulty disk drive), or when a process is simple, but dangerous (e.g., repairing network connections in a confined crawl space). However, with FSPs, contact with service recipients is often incidental. For example, when hardware fails and must be replaced, a service provider (e.g., an FSP technician) may accomplish the diagnosis of the problem, removal of the damaged hardware unit, installation of the replacement hardware unit, configuration, and testing. However, other than granting access, there may be no face-to-face contact between the service provider (e.g., the FSP technician) and service recipients.

Additionally, an FSP may be performed remotely from a service recipient's site. For example, a service recipient's site may be aligned with another site (e.g., a service recipient may lease a computer at a hosting site, e.g., a data center). Thus, rather than traveling to the service recipient's site, an FSP service provider (e.g., a technician) may travel to the hosting site to perform the FSP. As a further example of remotely provided services, when software fails, the FSP activities may be performed remotely from the service recipient's site (or host site), even though the affected software is running “in the field” at the service recipient's site (or host site) by, e.g., downloading a software patch to the service recipients system.

An FOP may be performed in, e.g., an office, a service center, or a service recipient's site. Furthermore, FOPs tend to be comprised of independent activities, usually of short duration (e.g., 3-4 minutes). For example, in an FOP, when a customer calls to make a purchase, the current purchase may generally be handled independently from previous purchases. Likewise, in an FOP, when a customer calls to report a problem, the problem may be recorded as either a new problem or a continuation, or reoccurrence, of a previous problem. However, after the recording of the problem (e.g., in a database or client record), the FOP may be complete. As such, with studies of an FOP, the unit of analysis is an individual contact, transaction, or activity.

BOPs and FSPs may be distinct from, yet operate in conjunction with, an FOP. For example, when a service recipient makes a request for service by contacting a service provider, that service request may be captured by an FOP. However, the information gathered by the FOP may be used to initiate a separate BOP, or to dispatch FSP technicians. On the other hand, an FSP may not operate in conjunction with an FOP. For example, an FSP may sometimes be initiated by remote monitoring instead of an FOP. That is, a service recipient's system may be remotely monitored and may detect a need for an FSP. Additionally, some BOPs may be highly automated even if the FOP is not.

In contrast to FOPs, BOPs and FSPs may be more often comprised of a series of dependent activities that make up an entire service (similar to an assembly line process). Additionally, BOPs and FOPs may be non-serial processes. Moreover, to complete the entire service, BOPs and FSPs may require multiple activities on multiple occasions, perhaps by multiple people or devices.

However, it is harder to quantify and analyze an entire instance of a BOP or an FSP when its activities are separated in time or space. Unlike studies of FOP, where the unit of analysis is an individual contact or transaction, the unit of analysis in BOP and FSP is an instance of an entire process, which is comprised of a set of activities performed on more than one occasion, perhaps at more than one location, by more than one person or device.

Accordingly, there exists a need in the art to overcome the deficiencies and limitations described hereinabove.

### SUMMARY OF THE INVENTION

In a first aspect of the invention, a method comprises collecting quantifying data to quantify each activity of a process, consolidating the quantifying data into a process record in a central location, and creating a process view from the process record, wherein the process view comprises at least an indication of a timing and duration of each activity of the process.

In additional aspect of the invention, a process quantification tool comprises a computer infrastructure operable to consolidate all collected activity quantifying data for a process from all data sources into a process record in a central location, and generate a process view of the process from the process record, wherein the process view indicates at least a timing and a duration of each activity of the process.

In a further aspect of the invention, a computer program product comprises a computer usable medium having readable program code embodied in the medium, and the computer program product includes at least one component to collect quantifying data to quantify each activity of a process, consolidate the quantifying data into a process record, and create a process view from the process record, wherein the process view comprises at least an indication of a duration of each activity of the process.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for managing the processes in accordance with the invention;

FIG. 2 shows an exemplary data entry screen of a data collection tool according to an aspect of the invention;

FIG. 3 shows an activity view according to an aspect of the invention;

FIG. 4 shows a diagram of an exemplary BOP;

FIG. 5 shows a process view of an exemplary BOP according to an aspect of the invention;

FIG. 6 shows a diagram of an exemplary remotely-detected FSP;

FIG. 7 shows a process view of an exemplary remotely-detected FSP according to an aspect of the invention;

FIG. 8 shows a process view of an exemplary client-detected FSP according to an aspect of the invention;

FIG. 9 shows a process view of an exemplary remotely-detected FSP according to an aspect of the invention;

FIG. 10 shows a process view of an exemplary asynchronous process according to an aspect of the invention;

FIG. 11 shows a process view of an exemplary time management of activities analysis according to an aspect of the invention;

FIG. 12 shows an exemplary box-and-whiskers chart according to an aspect of the invention; and

FIG. 13 shows an exemplary flow chart for practicing an aspect of the invention.

### DETAILED DESCRIPTION OF THE INVENTION

The invention relates to a method and system for quantifying and analyzing back office processes (BOP) and/or field service processes (FSP) in order to support capacity management, process improvement, and/or service level attainment. By implementing the invention, it is possible to collect quantifying data to quantify each of the activities of a process and consolidate the quantifying data from at least one source into a process record for the process. Moreover, it is possible to analyze the entire process, by generating activity views and process views based on the process record, in order to support capacity management, process improvement, and/or service level attainment.

BOPs and FSPs are similar in the sense that: (i) they may each be comprised of a set of activities which must be performed to deliver a service; (ii) those activities may be performed on more than one occasion, perhaps at more than one location, by more than one person or device (e.g., dozens of people and/or dozens of devices); and (iii) service time may often be a fraction of non-productive time, e.g., queue time, wait time, travel time. Therefore, quantifying BOPs and FSPs may require collecting data from multiple occasions, at more than one location, and by more than one person or device to collect data about each activity that makes up a single instance of an entire BOP or FSP. Moreover, analyzing those processes may require consolidating or aggregating the collected data into a process record. Moreover, quantification of the process may include quantifications of non-productive time, and analysis may compile relevant measurements together in order to represent an entire instance of the BOP or FSP.

According to an aspect of the invention, at least one data collection tool may be used to collect quantifying data, from multiple occasions and locations, about each activity that makes up a single instance of an entire BOP or FSP. By implementing this aspect of the invention, it is possible for a service provider (e.g., a technician) to collect quantifying data for each activity of a BOP or FSP that is provided by the technician. Moreover, by utilizing a plurality of data collection tools, different technicians performing different activities for a same BOP or FSP may each collect quantifying data for those activities of the BOP or FSP that are being performed by the different technicians.

Additionally, according to a further aspect of the invention, a process quantification tool consolidates the quantifying data collected by the at least one data collection tool (and automatically collected data) into a process record containing all of the quantifying data for the BOP or FSP. By implementing this aspect of the invention, it is possible to compile or aggregate all of the quantifying data gathered from different sources (e.g., different data collection tools and automatically detected data) into a single process record.

Moreover, the process quantification tool can generate an end-to-end view of a BOP or FSP service instance based on the quantifying data contained in the process record. In embodiments, the end-to-end view may be an activity view and/or a process view of the BOP or FSP. Subsequently, it is possible for an analyst to toggle between the activity view and the process view as necessary, to analyze the data presented in the two views. By implementing this aspect of the invention, it is possible to view and analyze the entire BOP or FSP in order to support capacity management, process improvement, and/or service level attainment.

According to a further aspect of the invention, the present invention quantifies and analyzes ancillary activities of a process. For example, team meetings, management, and quality assurance contribute indirectly to a given process, but they are nevertheless amenable to quantification and analysis. The present invention also is used to quantify and analyze asynchronous activities of a process, as well as to quantify and analyze time management of activities.

### System Environment

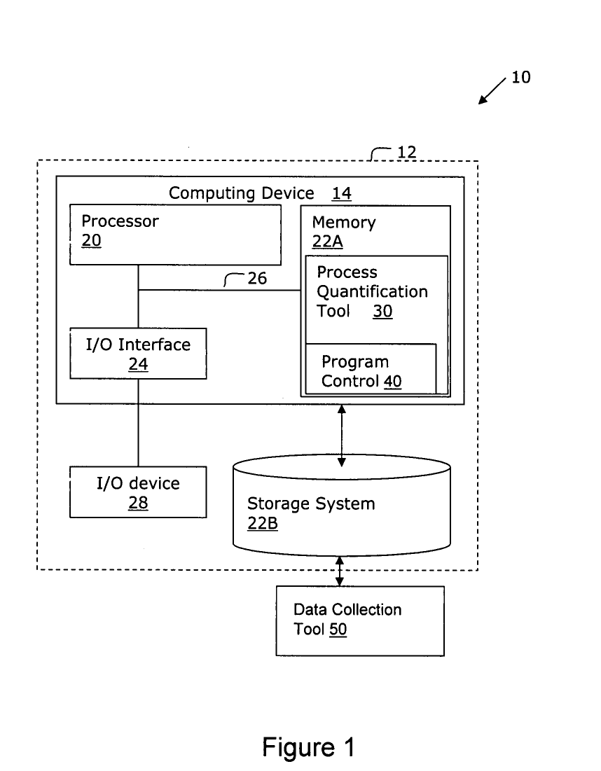

FIG. 1 shows an illustrative environment 10 for managing the processes in accordance with the invention. To this extent, the environment 10 includes a computer infrastructure 12 that can perform the processes described herein.

The computer infrastructure 12 includes a computing device 14 that comprises a process quantification tool 30 operable to compile or aggregate the collected quantify data (e.g., from data collection tools and the automatically collected data) into a process record for an instance of a BOP or FSP, and operable to generate an activity view and a process view of the BOP or FSP from the quantifying data contained in the process record, e.g., process described herein. The process quantification tool 30 quantifying individual activities of an overall process may help identify, or focus in on, leverage points that affect the process in order to increase efficiency of process. The computing device 14 includes a processor 20, a memory 22A, an input/output (I/O) interface 24, and a bus 26. The memory 22A can include local memory employed during actual execution of program code, bulk storage, and cache memories which provide temporary storage of at least some program code in order to reduce the number of times code must be retrieved from bulk storage during execution.

Further, the computing device 14 is in communication with an external I/O device/resource 28 and a storage system 22B. The external I/O device/resource 28 may be keyboards, displays, pointing devices, etc. Moreover, the process quantification tool 30 may display the activity view and/or the process view to an analyst on the external I/O device/resource 28 (e.g. on a display) connected via the I/O interface 24. Additionally, the process quantification tool 30 may use the storage system 22B to contain the complied or aggregated quantifying data collected from the different sources (e.g., at least one data collection tool and the automatically collected data).

In embodiments, a data collection tool 50 implementing aspects of the invention may be equipment (e.g., a computer) with software configured to allow a user (e.g., a technician) to collect quantifying data by starting and stopping timers for each activity and recording the resources consumed or utilized in performing those activities. For example, the data collection tool 50 may be a computer having a GUI with timer buttons. Furthermore, in embodiments, the data collection tool 50 may comprise discrete buttons to start and stop timers for each activity. Moreover, the data collection tool 50 may be compact (e.g., a laptop or a personal digital assistant (PDA)) to facilitate easy transport.

Moreover, the at least one data collection tool 50 may interface with the storage system 22B to transfer collected quantifying data from the data collection tool 50 to the storage system 22B for use by the process quantification tool 30. In embodiments, the data may be transferred from the at least one data collection tool 50 to the storage system 22B via a variety of methods (e.g., a direct connection or over wired or wireless protocols) as is understood by one of ordinary skill in the art.

The processor 20 executes computer program code (e.g., program control 40), which is stored in memory 22A and/or storage system 22B. While executing computer program code, the processor 20 can read and/or write data to/from memory 22A, storage system 22B, and/or I/O interface 24. The bus 26 provides a communications link between each of the components in the computing device 14. The I/O device 28 can interact with the computing device 14 or any device that enables the computing device 14 to communicate with one or more other computing devices using any type of communications link.

The computing device 14 can comprise any general purpose computing article of manufacture capable of executing computer program code installed thereon (e.g., a personal computer, server, handheld device, etc.). However, it is understood that the computing device 14 is only representative of various possible equivalent computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a server cluster) that communicate over any type of communications link, such as a network, a shared memory, or the like, to perform the processes described herein. Further, while performing the processes described herein, one or more computing devices in the computer infrastructure 12 can communicate with one or more other computing devices external to computer infrastructure 12 using any type of communications link, such as, e.g., to the data collection tool 50. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a service provider, such as a Solution Integrator, could offer to perform the processes described herein. In this case, the service provider can create, maintain, deploy, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

### Preparation for BOP or FSP Study

According to an aspect of the invention, prior to collection of the activity quantifying data, a preparation for a BOP or an FSP study may be performed. In embodiments, this may include: (i) determining the research questions to be answered by the study; (ii) configuring the at least one data collection tool 50, (iii) for each type of data collected (e.g., time duration), defining aggregation parameters (e.g., how the process quantification tool 30 aggregates those data values from activity records into service records); and/or (iv) entering predefined analysis parameters.

Thus, according to an aspect of the invention, prior to conducting a BOP or FSP study, the research questions to be answered by a BOP or an FSP study may be determined. By determining the research questions first, the chances are reduced that quantifying data needed for answering a research question is not collected. For example, if a company's parts' depots include both a near depot and a far depot, distinguishing between the two depots in quantifying travel time may be very relevant in analyzing the process (e.g., an FSP). However, if the importance of distinguishing between the different parts depots was not set forth in preparing for the study, the study may not be set up to distinguish between the two parts depots when collecting parts depot travel time data.

Moreover, according to an aspect of the invention, if a distinction may be needed between, e.g., two parts depots, each depot may have an assigned unique identification. When activities involving a particular parts depot occurs, the unique identification may be used to identify that particular parts depot. A unique identification may also be used for other data.

Additionally, in embodiments, a preparation for a BOP or an FSP study may be performed after the collection of quantifying data. That is, according to a further aspect of the invention, the research questions may not be determined prior to conducting a study of a BOP or an FSP; rather, all pertinent data may be collected, such that any specific research question may be analyzed and answered.

Furthermore, in embodiments, a database (e.g., storage system 22B) of predetermined research questions with a list of corresponding data that is needed for collection to answer a particular predetermined research question may be used by a designer of the study. By using the predetermined questions, a designer of a BOP or FSP study can efficiently create a study and can efficiently configure the at least one data collection tool 50. For example, a researcher may need to study a particular question “A”. The researcher may review the database of research questions to find question “A”. The database may also indicate what data should be collected to answer question “A”, and, as such, a researcher (designer) does not have to recreate a study (and the corresponding data collection tool) with each new study. Rather, the researcher may build off of preexisting research questions contained in the database, such as the storage 22B.

Moreover, a researcher may pick and choose among a list of studies and related questions to design a custom study. For example, a researcher may use question 1 from study “X” and question 3 from study “Y”. Additionally, a researcher may add new questions to an already existing study.

The database of research questions (e.g., contained in storage system 22B) may be organized by categories to assist the researcher in designing the study. In embodiments, these categories may be based on the type of process (e.g., BOP, FSP, asynchronous, etc.). Additionally, the database may be categorized in other ways, e.g., type of client, client, region of service, etc.

Some examples of research questions may include: Is there a specific shortcoming in a process that needs to be improved, such as reducing cycle time or improving service recipient satisfaction? Which activity occurs most often? Which activity requires the most time per instance? Which activity requires the most time in total? Are there differences in performance between service centers? From the time a service request is opened until it is closed, what percent is queue time, wait time, and service time? Would the process be more efficient or effective if the activities were configured another way? Where would technology improve the process?

Additionally, in preparing for a BOP or FSP study, the at least one data collection tool 50 may be configured. As explained further below, a BOP or an FSP service provider may use at least one data collection tool 50 to manually or automatically gather relevant quantifying data (e.g., time spent on each activity) for quantification and analysis of the BOP or FSP. More specifically, in configuring the data collection tool 50, the names of activities to be quantified may be entered into the data collection tool 50. In embodiments, these activity names may appear, e.g., on or adjacent to buttons that activate and deactivate timers so that timers may be started and stopped coincident with each activity of entire process.

The data collection tool 50 may be further configured by entering lists of service centers, tools, parts, and other resources that may be consumed or utilized in carrying out a BOP or an FSP. In embodiments, these resources may appear in lists or on, or adjacent to, buttons that activate and deactivate timers or indicate the consumption or utilization of a resource. Moreover, as discussed below, these resource names (e.g., service centers, tools, parts, and other resources) and their related quantifying data may be uploaded and stored in a central location, e.g., a database.

The data collection tool 50 may be further configured by entering custom questions, their data types, and validation criteria. In embodiments, custom questions and valid values may appear in the data collection tool in, e.g., lists, checkboxes, and blanks to be completed. Moreover, as discussed below, these custom questions and their related quantifying data may be uploaded and stored in a process record in a central location, e.g., a database in the storage system 22B.

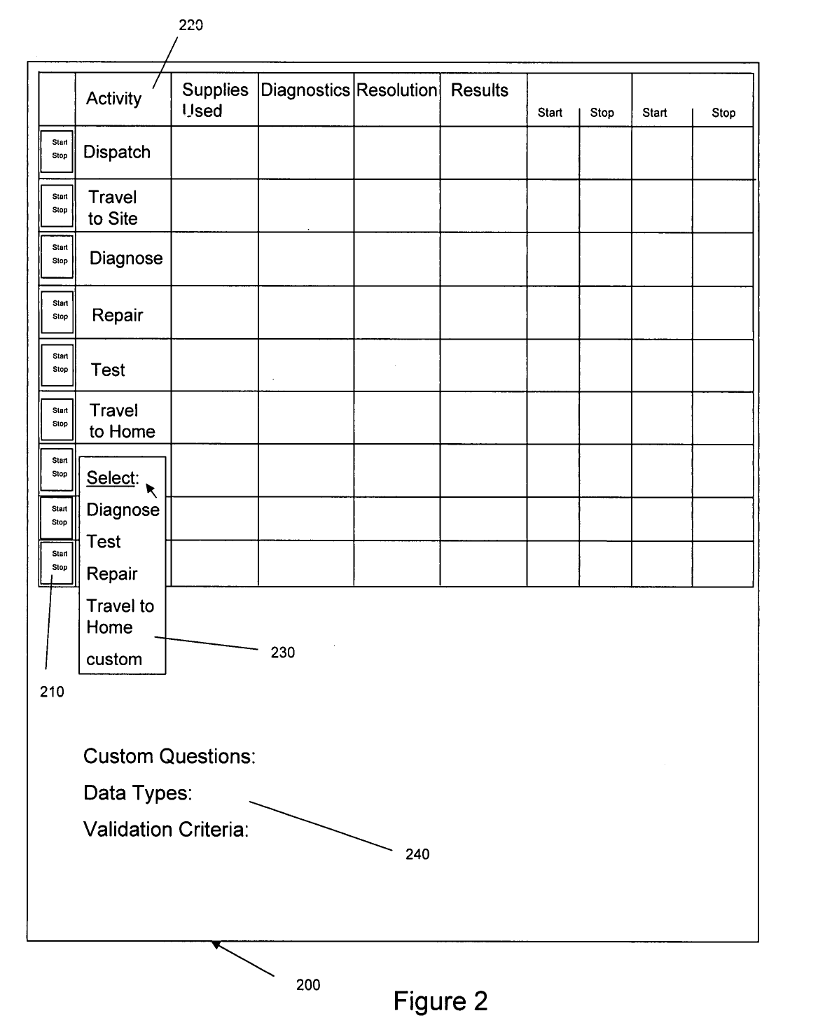

FIG. 2 shows an exemplary data entry screen for the data collection tool 50. This is an illustrative example and should not be considered a limiting embodiment. As shown in FIG. 2, a GUI data entry screen 200 may include timer start/stop buttons 210 for the different listed activities 220. Moreover, the GUI data entry screen 200 may include drop down lists 230 (only one shown) to facilitate the entry of data (e.g., activities, supplies used, etc.). Additionally, the GUI data entry screen 200 may include data fields 240 for custom questions, along with the data types and validation criteria.

Furthermore, in preparing for a BOP or FSP study, a researcher/analyst may define how the quantifying data (e.g., each variable, values, or collected data) will be aggregated from activity records (e.g., the collected quantifying data, e.g., contained on individual data collection tools) into service records. In embodiments, timers (floating point numbers), button click counters (integers), and other numeric values may be automatically summed. Furthermore, average, maximum, and minimum values are additional options for aggregation of other numeric values. For example, if service recipient satisfaction is measured on a numeric scale of 1 to 10, the average, maximum, minimum, and standard deviation values conform to that scale (e.g., 1 to 10), and thus would be meaningful. In contrast, the sum of the collected satisfaction measures may not be meaningful.

In embodiments, date and time values may be handled several ways at once. For example, the earliest values across all activities may typically be recorded as the start of service, while the latest values may be recorded as completion of service. Moreover, durations may be calculated at the activity level and at the service level (e.g., each activity lasted 3 minutes on average, but the service required 30 minutes from start to finish).

In embodiments, Boolean values may be matched or counted. That is, if all activity records are true (or false), the corresponding service record would be true (or false). If some activity records were true and others false, the service record may be coded as “mixed.” Alternatively, a Boolean variable in activity records can be aggregated as separate counts of true and false values in the service record. This enables the analysis later to calculate the proportion of true values (e.g., only 20% of the activities used a standard tool).

In embodiments, values picked from lists may likewise be preserved if unique, or converted to “multiple” if not unique. For instance, if all activities were performed at the same service center, the service center's identifier may be carried forward. Alternatively, the count of each value may be stored separately in the service record. This enables the analysis later to calculate the proportion of various values (e.g., 65% of the activities were performed at service center X, 25% at Y, and so forth). In embodiments, values from fill-in-the-blank questions may not be aggregated into the service record, but may be retained in activity records for later reference, if necessary.

Furthermore, in preparing for a BOP or FSP study, predefined analysis parameters may be entered by a researcher/designer. Each type of predefined analysis may later be activated by selecting from a predefined list. For example, a comparison of selected activities by specific service centers may be analyzed in, e.g., a stacked bar chart, as discussed further below. Selection of which activities and service centers are displayed may be predefined or deferred until the chart is generated.

### Quantification of Activities

The system and method may quantify activities performed as part of a BOP or an FSP. For example, a typical FSP may comprise a series of activities (e.g., a technician receiving a request, traveling to a parts depot, picking up a part at the parts depot, traveling to a service recipient's site, diagnosing the problem, replacing the part, testing the repaired device, cleaning up the work site, traveling to the parts depot to recycle the old part, and traveling home). Moreover, each of these activities may consume a portion of the technician's time.

Quantifying individual activities, or even a subset of activities, that make up an entire process of a BOP and/or an FSP may not allow for an accurate quantification or analysis of the entire process. Rather, quantification and analysis of an entire process of BOPs and/or FSPs is most effective when every activity comprising each instance of the process is quantified. Therefore, according to an aspect of the invention, data may be gathered about multiple activities on multiple occasions by multiple people and/or devices, and compiled together to quantify the overall process.

Activities that make up a process may include automated activities and manual activities. Moreover, quantification of each of those activities, or collection of the quantifying data, may occur automatically or manually.

Automated activities may automatically be measured by the system or device performing the activity, and those measures may be captured in activity records that can be read by the either the data collection tool 50 or the process quantification tool 30. For example, a start time, an end time, a number of records rejected, and a number of records processed in a BOP may be captured automatically, by the systems performing that BOP. As a further example, a global positioning system (GPS) may be used to automatically collect data in an FSP. More specifically, a GPS may automatically determine departure times and arrival times of a service provider to the different locations involved in performing a BOP or FSP (e.g., home site, service recipient's site, parts depot site). Furthermore, a GPS may automatically collect other data (e.g., the time spent waiting at traffic lights, the time spent waiting to make left turns, routes taken, and time of day parameters) so that an analysis of travel time may be studied in greater depth.

Manual activities may be measured by a human observer (e.g., a technician) performing the activity who may use multiple timers built into the data collection tool 50. For example, separate timers can be run in series (or parallel) to capture time spent on travel, diagnostics, repair, and testing in an FSP. In embodiments, the data collection tool 50 also may allow for timers to run concurrently. For example, a service provider (e.g., a technician) may start a timer when beginning an activity. Furthermore, while the first timer continues to run, the technician may begin a second timer when beginning to use a system to perform the activity. Moreover, while the first and second timers continue to run, the technician may begin a third timer when beginning to use a particular function within the system. Upon completion of the activity, the technician may stop all three timers. Additionally, manual activities may be measured by devices used by the technician (e.g., a magnetic swipe entryway). That is, in some cases, data about activities can be gathered as a by-product of the activities, for example when a magnetic card is swiped to enter or leave a location (e.g. indicates an arrival time and a departure time).

Thus, the data collection tool 50 may contain quantifying data which indicates how long was spent on the activity (timer 1), how long was spent using the system to perform the activity (timer 2), and how long was spent using a particular function of the system (timer 3). In embodiments, these data values may be used together or separately in quantifying the technician activity to analyze the process.

Additionally, in embodiments, the timers may automatically stop upon the commencement of another activity (e.g., a mutually exclusive activity). For example, a technician may start a timer in the data collection tool 50 upon beginning an activity (e.g., travel to a client site). Upon arrival to the client site, the technician may start a second timer for a second activity (e.g., diagnosing the problem). As the diagnosing activity may require the technician to be at the client site, the data collection tool 50 may be configured to automatically stop the first timer (recording the travel time) upon the technician starting the second timer (recording the diagnoses time).

According to an aspect of the invention, the data may be gathered contemporaneously with the performed BOP or FSP activities. The contemporaneous gathering of information eliminates inaccuracies (e.g., recall errors or false memories) that may occur with post-hoc data gathering, e.g., time reporting. Additionally, the contemporaneous gathering of information enables more detailed data gathering than can reasonably be expected with purely self-reporting. Furthermore, by collecting the combination of data about manual activities and automated activities, the process quantification tool 30 may quantify and analyze both types of BOP and FSP activities.

Furthermore, in embodiments, the data collection tool 50 may be used to quantify the activities of a single service provider (e.g., a technician) performing multiple overlapping or simultaneous processes. For example, a single technician may perform two FSPs at a same site. Thus, the data collection tool 50 may be configured appropriately, depending on the determined research questions. For example, if the study is designed to analyze the technicians travel time, it may be important not to double count the travel time, e.g., the travel time to the site to perform a first FSP and the same travel time to the same site to perform a second FSP. However, if the study is focused on the processes themselves (e.g., the first FSP and the second FSP) it may be legitimate to count the travel for each process, even though the technician only traveled once.

Additionally, in embodiments, the data collection tool 50 may comprise predefined drop down lists to identify, e.g., activities performed and resources consumed, during a BOP or FSP and data fields for activity related data (e.g., classifications, type of problem, resolution). Furthermore, the data collection tool 50 may allow for other activity identifiers (and related data fields) to be added.

For a particular BOP or FSP, the entire process may be comprised of a number of activities, determined by the process under study. For example, the entire process may be comprised of 2-3 dozen activities. Thus, for a given BOP or FSP, the timing data may comprise hundreds of data points. Furthermore, for each identified activity, the data collection tool 50 may generate a record or object for each instance of an activity. For example, the data collection tool 50 may generate a row in a database (e.g., contained in a storage of the data collection tool 50) having data fields to contain data points (e.g., timing data) for each activity. Thus, with the data collection tool 50 of the present invention, the number of concurrently handled data collection occurrences may be effectively unlimited. Additionally, the amount of data collected, either automatically or manually, and the number of different data collection tools 50 involved in a particular process may be effectively unlimited.

Also, as should be understood, the data collection tool 50 may be used to collect or record quantifying data reflecting, for example, a time spent performing an activity, skills utilized performing an activity, supplies consumed performing an activity, technology used performing an activity, problems encountered performing an activity, standards met performing an activity, results achieved performing an activity, and service recipient feedback, if any.

More specifically, in embodiments, in order to analyze a BOP or an FSP quantifying data that may be collected may include, amongst other non-limiting examples:
Classifications: problem type, service type, service center, service recipient type, urgency, automatic vs. manual detection, automatic vs. manual resolution, amongst other classifications;
Descriptors: activity identifier, reason for service request, date & time when service request received, date & time when service started, date & time when service completed, amongst other descriptors;
Timers: amount of time spent on each occurrence of each activity, with travel being counted as a separate activity;
Sequencing: predecessors and successors to current activity, if not predetermined;
Diagnostics: what was the proximal cause of the problem?, what was the root cause?, amongst other diagnostics;
Resolution: what eliminated some potential solutions?, if more than one solution was tried, which were effective?, amongst other resolutions; and
Results: final resolution, service recipient satisfaction, amongst other results data.

In embodiments, the data collection tool 50 also collects sequencing data, which may be important to understanding a BOP or an FSP. More specifically, collecting sequencing data may ensure that, if a particular activity is repeated (e.g., returning again to a parts depot to acquire another replacement part needed for a particular FSP instance), the effect of the repeated activity may be accounted for in the study of the BOP or FSP, in order to minimize repeated activities in future BOPs and FSPs.

In embodiments, the data collection tool 50 also collects quantifying data regarding predictive analysis, which may also be important to understanding a BOP or an FSP. The collecting quantifying data regarding predictive analysis may be used in a BOP or FSP to minimize or eliminate repeating an activity or activities. For example, if in conducting an FSP (e.g., a repair of part “A”), a service provider (e.g., a technician) determines that part “B” is on the brink of failure, upon traveling to a parts depot to acquire part “A”, the technician may also pick up part “B”. This may eliminate another trip to the parts depot at a later time, and may further eliminate an entire subsequent FSP request (e.g., the replacement of part “B”).

The predictive analysis may be pertinent to hardware devices that may tend to fail in a more predictable way (e.g., overall device duration). Additionally, predictive analysis may be used for software; however, software failures may be less amenable to predictive analysis, as software failures may be due to the occurrence of a precise series of events, and are less due to durational failures.

As set forth above, data capture may be customized for each study. That is, a particular study may be designed (and a data collection tool 50 configured) to answer specific questions, or analyze specific parameters, as determined in the preparation of the BOP or FSP study. Moreover, the customizations may flow automatically from data capture to data analysis. That is, variable names, corresponding data types, and valid values may be defined during customization and preparation of the BOP or FSP study. These characteristics may then determine valid types of analysis. Additionally, the specific analysis needed to answer research questions can be defined in advance, then invoked later by selecting questions from a predefined list.

After collection of the data, analysis may begin with the process quantification tool 30 consolidating the data for a particular process from the disparate sources (e.g., the at least one data collection tool 50 and the automatically collected quantifying data) into a process record in a central location, e.g., a database in the storage system 22B. That is, for example, a number of FSP service providers (e.g., technicians) may be operating separately in different locations in completing the same FSP. Each of these technicians may use their own data collection tool 50 to record their quantifying data for the activities they perform (e.g., activity durations). In order to subsequently quantify and analyze the entire FSP, each of the technicians' collected quantifying data may be uploaded to a central system (e.g., a database in the storage system 22B) and the process quantification tool 30 may compile the quantifying data into a single process record representing the entire instance of the FSP. Additionally, as explained further below, data collected automatically by other systems may be imported into the process record. Thus, since data may be collected on multiple occasions, perhaps at multiple locations, and perhaps by multiple people, the process quantification tool 30 consolidates the data from the disparate sources together into one process record.

### Analysis of Services

The collected quantifying data may be used to analyze an entire instance of a BOP or an FSP. Analysis proceeds to correlation and aggregation of related activity records into a single process record. That is, the process quantification tool 30, using common keys (e.g., the activity key identifiers and a process key identifier), identifies and aggregates all the quantifying data for a complete instance of a process into a single process record representing the entire process. Furthermore, the process quantification tool 30 may aggregate the activity records (e.g., the individually collected quantifying data) into a process record by applying the aggregation parameters. Additionally, all of the individual activity records may be retained so that the analysis may include drilling down from an aggregated process record back to the activity records.

In order to associate quantifying data of a particular activity with a specific BOP or FSP, the data collection tool 50 may identify all quantifying data measuring instances of activities pertaining to the specific BOP or FSP by a common key (e.g., an activity key identifier). In embodiments, the common key may be a case number, service request (SR) number, program maintenance request (PMR) number, or merchandise return authorization (MRA) number. Additionally, the data collection tool 50 may store the common key, for example, in a column of the database or memory of the data collection tool. Moreover, the process quantification tool 30 may use the common key to aggregate the quantifying data into a process record, as discussed further below.

Capturing common keys can be performed via several methods, including amongst other non-limiting examples:
Scanning of bar codes, optical character recognition, magnetic character recognition, radio frequency identification, etc.;
Picking from a list, such as all cases pending or just previous cases associated with a given service recipient, or perhaps further limited to previous cases assigned to a given service provider; and
Manual entry by keyboard, handwriting, or voice recognition.

Moreover, according to an aspect of the invention, when common keys have standard formats, such as XXX-99-999, where X=alphabetic and 9=numeric, keys can be edited against the standard to trap and correct errors at their source. Furthermore, when a key must match a pre-existing value (for example, time can only be tracked against open trouble tickets), invalid values may be trapped and corrected at their source.

The process quantification tool 30 may generate an activity view from the aggregated quantifying data. More specifically, the activity view may comprise a list of all the activities performed for a particular BOP or FSP (e.g., in a database view or a spreadsheet format) along with the related quantifying data for each of those activities. This activity view may be similar to the data entry screen view 200 of individual data collection tools 50 (e.g., FIG. 2). However, the activity view includes every activity and related quantifying data for the entire instance of the BOP or FSP. That is, whereas the data entry screen 200 of a data collection tool 50 may only have quantification data for those activities performed by one service provider (e.g., a single technician), the activity view is a consolidation of the quantifying data for all activities performed by every service provider involved in completing the particular BOP or FSP.

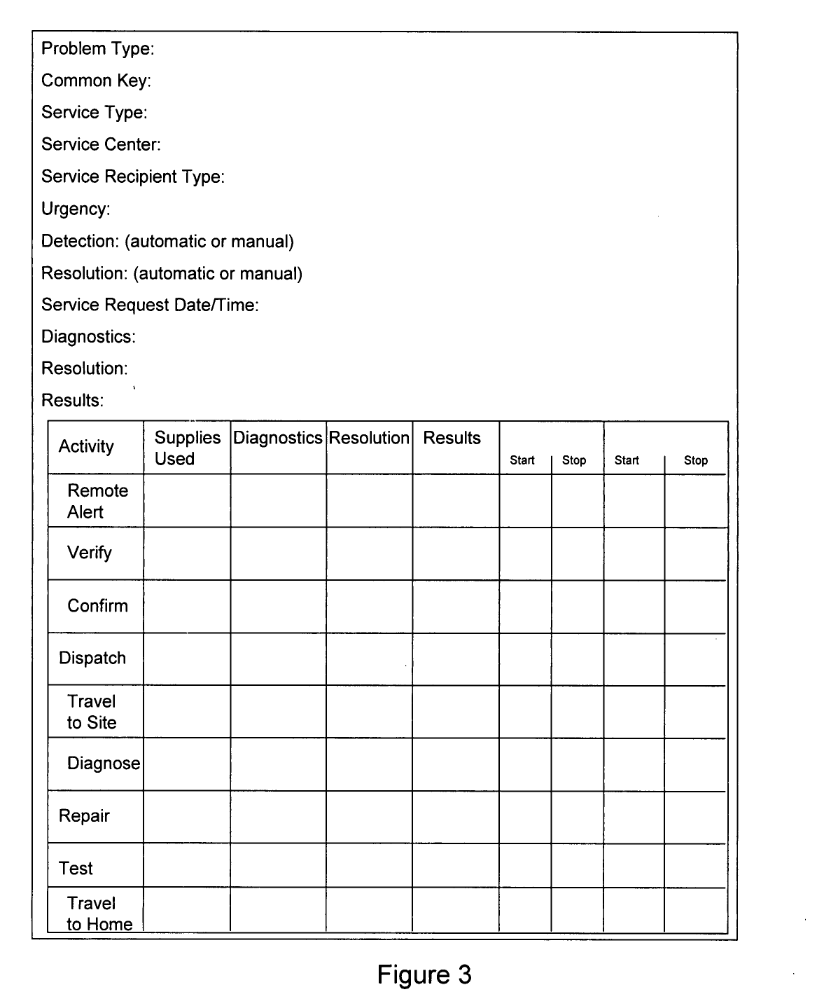

FIG. 3 shows an exemplary embodiment of an activity view according to an aspect of the invention. This is an illustrative example and should not be considered a limiting embodiment. As shown in FIG. 3, the activity view may include classification data (e.g., problem type, service type, service center, service recipient type, urgency, detection type, and resolution type), descriptors (e.g., activity identifiers, service request data) timers, sequencing, supplies used, diagnostics, resolutions, and results. For example, reason codes may explain why a particular service request was made. Additionally, there may be columns for diagnostics, resolutions, and results, so that diagnostics, resolutions, and results information may be identified for individual activities.

Further, as shown in FIG. 3, there may be columns for starting and stopping times for each activity. Moreover, there may be multiple timer columns for each activity. For example, in embodiments, a technician may perform some activities (e.g., iterations of diagnose, repair, and testing), where the timer may be started and stopped multiple times for a particular activity. Thus, as shown in FIG. 3, additional columns may be added to accommodate this additional quantifying data.

In further embodiments, an additional row may be added for a repeated activity, such that an activity view may have multiple rows for e.g., diagnose, repair, and testing, with each row only containing a single pair of start and stop times.

Furthermore, the process quantification tool 30 may generate a process view for a particular BOP or FSP from the aggregated quantifying data. That is, using the aggregated quantifying data contained in the process record, the process quantification tool 30 can determine, e.g., durations of each of the activities performed for the BOP or FSP and a sequence of those activities. In embodiments, the process view may comprise charts, tables, and statistics generated by choosing among predefined analysis parameters. Moreover, the process quantification tool 30 may generate custom charts, tables, and statistics by entering new analysis parameters.

Additionally, in embodiments, process-related data that may be reflected in the process view may include amongst other non-limiting examples:
Classifications: distribution of service by problem type, service type, service center, etc.;
Descriptors: distribution of service by reason code, time of day, day of week, week of year, etc.;
Counters: number of times each activity occurs;
Paths: number of times a specific sequence of activities occurs, especially non-standard paths;
Durations: total amount of time spent on each activity, including all occurrences;
Timeliness: difference between date & time when activity is due versus when it was actually completed;
Results: process error rate, process rework rate, process satisfaction rate, problems resolved on first try; and
Leverage points: places where relatively small changes may yield big benefits, such as introducing a new diagnostic or automating an activity.

Additionally, in embodiments, service attributes may be created, for example, by counting the number of activities per service request and the number of individual technicians performing those activities.

### Analysis of a BOP

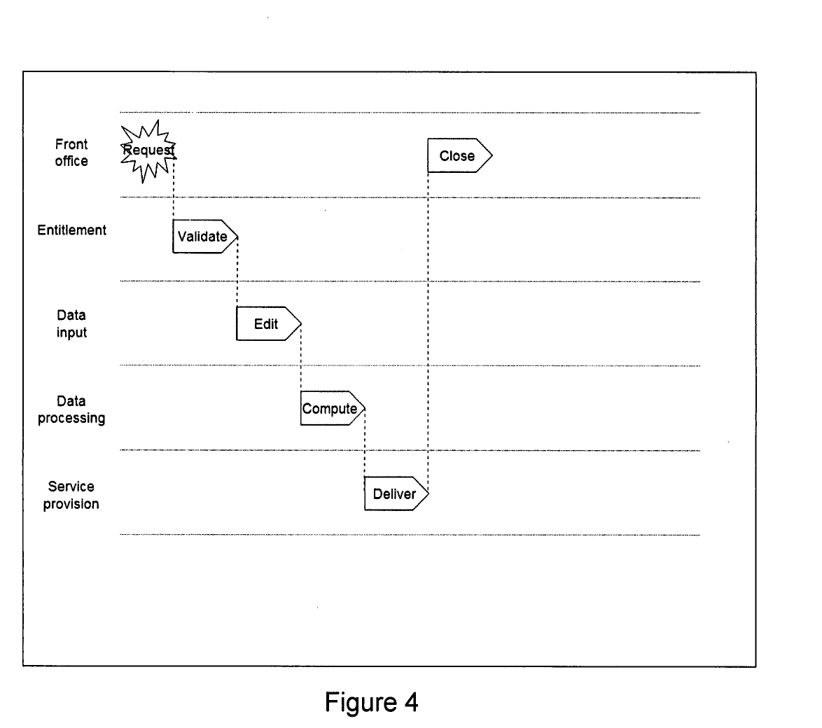

FIG. 4 shows a diagram illustrating an exemplary BOP. Such diagrams are sometimes called “swim-lane” diagrams and may be used to design a particular process, e.g., setting forth which are the steps involved in completing a particular BOP. An actual BOP may be far more complicated, including simultaneous activities; however, this example is sufficient for illustration purposes in order to understand the invention. The horizontal dimension represents time and the vertical dimension represents place (or role).

The exemplary BOP may comprise a series of activities (e.g., a “Request” activity, a “Validate” activity, an “Edit” activity, a “Compute” activity, a “Deliver” activity and a “Close” activity). More specifically, the “Request” activity may include a service requester/recipient opening a service request. The “Validate” activity may include the service provider ensuring that a service requester is entitled to service (e.g., is under warranty or has paid for a repair service). The “Edit” activity may include the service provider gathering and confirming data from the service requester/recipient. The “Compute” activity may include the service provider calculating whatever is required by the service (e.g., a delivery schedule). The “Deliver” activity may include the service provider providing the service (e.g., picking up and shipping materials). The “Close” activity may include a service provider changing a service request status to complete.

Additionally, as shown in FIG. 4, the diagram shows a sequence of activities, but not a duration of those activities. That is, the width of each activity symbol is the same, regardless of expected or actual duration. Furthermore, the diagram of FIG. 4 does not include iterations, non-productive time, or non-standard activities. Therefore, the diagram of FIG. 4, may be an adequate representation of what activities should be done under normal circumstances, but it does not reflect what actually may happen during an actual BOP (particularly under abnormal circumstances).

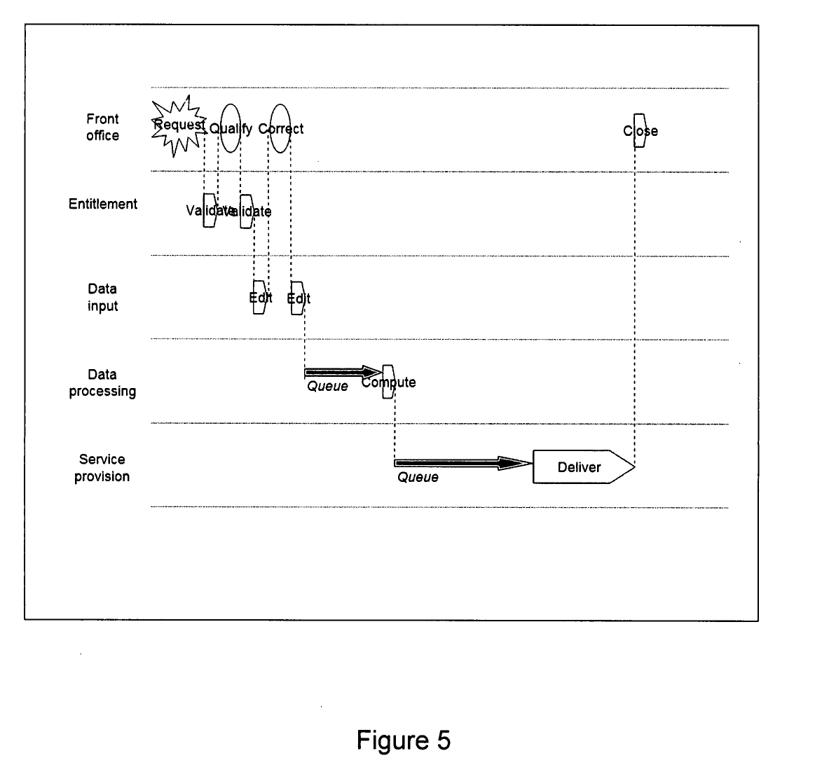

FIG. 5 shows an output of the process quantification tool 30 illustrating a process view of the exemplary BOP process shown in FIG. 4 according to an aspect of the invention. In a similar manner to FIG. 4, FIG. 5 shows a sequence of activities of the exemplary BOP. However, in contrast to FIG. 4, the process view of FIG. 5 shows a duration of each of these activities. That is, the width of each activity symbol is indicative of the duration of that activity. As discussed above, the process quantification tool 30, using the aggregated quantifying data, can determine durations of each of the activities of a process.

Furthermore, as shown in the process view of FIG. 5, the process quantification tool 30 accounts for the iterations in the overall BOP. That is, the process quantification tool 30, using the aggregated quantifying data, can determine instances and durations of iterations that occur during the process. For instance, in the exemplary BOP, a first iteration occurs in determining whether a service requester is entitled to service. That is, while the “Validation” activity is shown in FIG. 4 as a single validation symbol, in reality, the “Validation” activity may actually involve some back-and-forth communication (e.g., between a front office and an entitlement determiner) and expenditure of time to accomplish the validation. Additionally, in this exemplary BOP, a second iteration occurs in obtaining correct data from the service requester. That is, while the “Edit” activity is shown in FIG. 4 as a single edit activity symbol, in reality, the “Edit” activity actually involves some back-and-forth communication (e.g., between an entitlement determiner and a service requester) and expenditure of time to accomplish the edit.

Additionally, as shown in the process view of FIG. 5, the process quantification tool 30 accounts for the non-productive time in the overall BOP and determines an approximate quantification of actual durations of those non-productive activities comprising the BOP. That is, the process quantification tool 30, using the aggregated quantifying data, can determine instances and durations of non-productive time that occur during the process, based upon the quantifying data gathered by the data collection tool 50. Also, the exemplary BOP includes non-productive time comprising a queue in data processing and a queue in service provision. Thus, whereas FIG. 4 only indicates the occurrence of a “Compute” activity and a “Deliver” activity, as shown in FIG. 5, the process quantification tool 30 indicates and quantifies that these activities actually involve some queuing and non-productive time. Additionally, as shown in FIG. 5, the length of the activity symbols are compressed to illustrate their short durations relative to the non-productive time.

In an actual instance of a BOP, with the horizontal axis drawn to scale, queue time may frequently account for 90% or more of end-to-end service time. Queues may occur, for example, when: (i) the service provider does not have enough capacity to process everything on demand; or (ii) processing occurs periodically (i.e., in “batch” processing). Therefore, queues represent another potential leverage point, which may only be identified when activity durations are measured.

### Analysis of a Remotely-Detected on-Site FSP

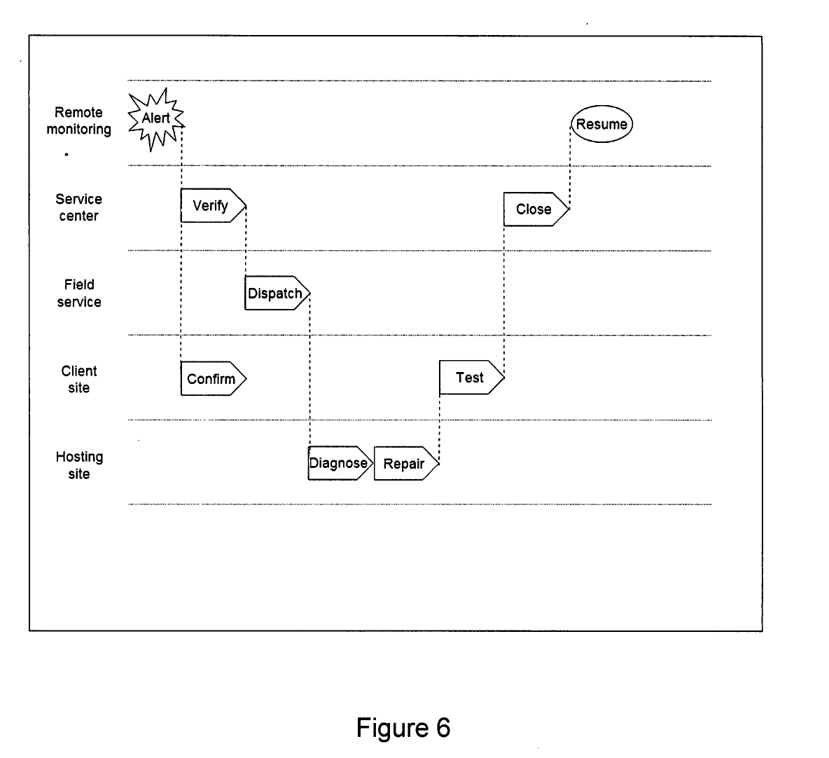

FIG. 6 shows a swim-lane diagram illustrating an exemplary FSP. However, like the BOP depicted in FIG. 4, FIG. 6 shows only the sequence of the activities of the exemplary FSP, but not the duration of those activities and other non-productive time. Additionally, as shown in the exemplary FSP of FIG. 6, the need for the FSP is detected remotely. Remote detection may occur when, for example, a device automatically communicates with a FSP service provider that the device is in need of repair.

Furthermore, FIG. 6, shows a series of activities involved in the exemplary FSP, which include an “Alert” activity, a “Verify” activity, a “Confirm” activity, a “Dispatch” activity, a “Diagnose” activity, a “Repair” activity, a “Test” activity, a “Close” activity, and a “Resume” activity. More specifically, the “Alert” activity may include a remote monitoring detecting a problem, or conditions that predict a problem, such as a rise in temperature of a server or a decline in response time of a disk drive. The “Verify” activity may include a service provider determining if the alert is not a false positive, and if so, opening a service request. The “Confirm” activity may include a service provider determining whether the client may be observing the same remotely detected problem. The “Dispatch” activity may include a service provider sending a field service technician to the service recipient's site (or remote site). The “Diagnose” activity may include, for example, a service provider determining what is failing and why, if possible. The “Repair” activity, for example, may comprise a service provider adjusting or replacing hardware, and/or reinstalling/rebooting software. The “Test” activity may include a service provider making sure that the repair activity has resolved the problem. The “Close” activity may include, for example, a service provider changing the status of the service request to complete. The “Resume” activity may begin the remote monitoring again.

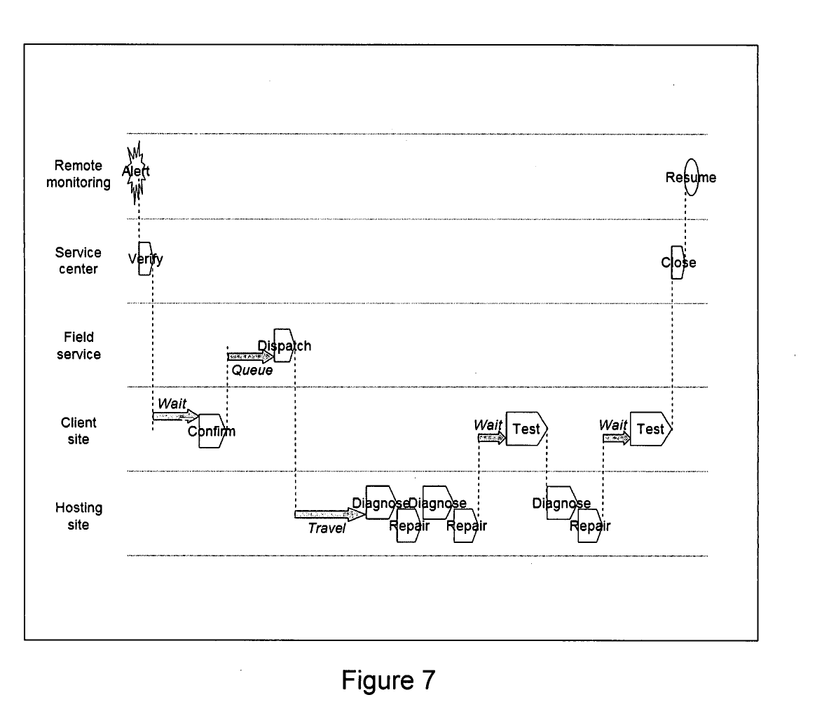

FIG. 7 illustrates an output of the process quantification tool 30 illustrating a process view of the exemplary FSP shown in FIG. 6, where remote monitoring detects a problem that must be resolved on-site. In a similar manner to FIG. 6, FIG. 7 shows a sequence of activities comprising an exemplary FSP. However, in contrast to FIG. 6, FIG. 7 also indicates a duration of each activity. That is, the width of each activity symbol is indicative of the duration of that activity.

Furthermore, as shown in the process view of FIG. 7, the process quantification tool 30 may account for iterations in the overall FSP. For example, a few iterations are involved in the “Diagnosing”, “Repairing” and “Testing” activities. That is, while these activities are shown in FIG. 6 as activities performed once (e.g., one diagnoses, one repair and one testing), in reality, a service provider (e.g., a technician) may require a few diagnoses, a few repairs and a number of testing activities, in order to accomplish the FSP.

It might be tempting to conclude that two cycles of diagnose, repair, test are worse than one, but this may not necessarily be the case. Of course, if an inexperienced technician “botched” the initial cycle and had to redo it, that is a skills issue, or if the replacement unit was defective, that is a supply issue. However, if a skilled technician anticipated that additional components were on the verge of failing and repaired them while on-site, another instance of this FSP might have been avoided entirely, which eliminates costs to the client by reducing time spent by the service provider. Thus, the outcome of the FSP may be quantified in order to determine whether the additional diagnose, repair, test cycle was detrimental or beneficial.

Additionally, as shown in the process view of FIG. 7, the process quantification tool 30 accounts for the non-productive time in the overall FSP and determines an approximate quantification of actual durations of the non-productive activities comprising the FSP. For example, as shown in the exemplary FSP of FIG. 7, non-productive time in an FSP may include wait time, queue time and travel time, amongst other non-productive time. A wait time may occur when a service provider has sufficient capacity to perform a next activity, but cannot progress because the next activity is blocked by the client or a third party. In this example, wait time may not be a major factor, but in situations where clients are dissatisfied with end-to-end service time, the service provider may determine whether client-induced wait time is significant, since the client-induced wait time may not be a leverage point under the service provider's control.

Thus, whereas FIG. 6 only indicates the occurrence and sequence of activities, the process view of FIG. 7 indicates that these activities actually involve some non-productive time (e.g., waiting, queuing, and travel) and quantifies the durations of the activities, including the non-productive time. As shown in FIG. 7, the activity symbols are compressed to illustrate their short durations relative to the non-productive time.

### Analysis of a Client-Reported on-Site FSP

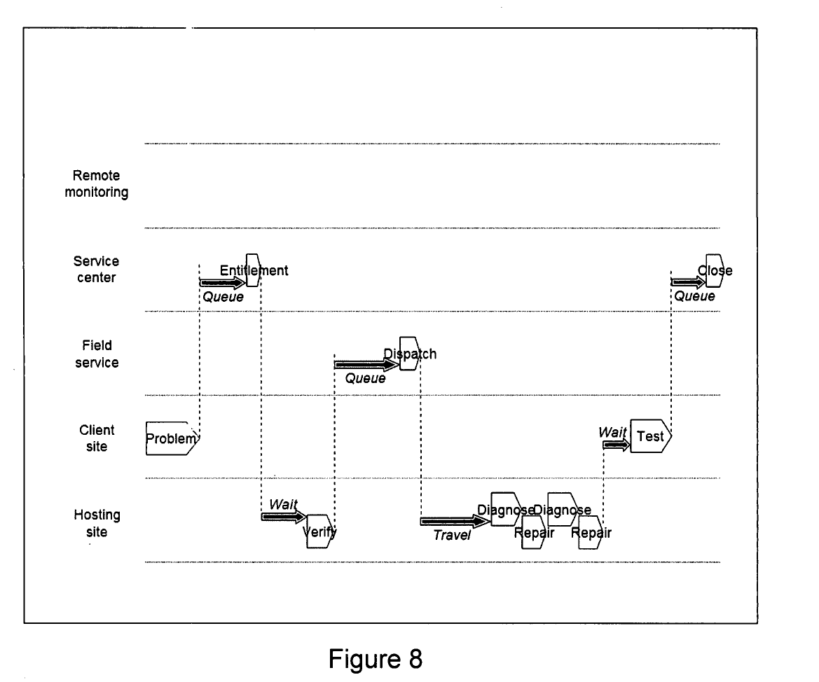

FIG. 8 illustrates a process view output of the process quantification tool 30 for an exemplary instance of an FSP, where a client reports a problem and the repair is performed on-site at a client's remote site. In contrast to the process view of the exemplary FSP of FIG. 7, with the process view of the exemplary FSP shown in FIG. 8 remote monitoring did not detect this particular problem. Thus, as shown in the process view of FIG. 8, a non-trivial portion of the end-to-end process is used in capturing the service request, ensuring the client is entitled to service, and verifying that the problem really exists as reported by the client.

Furthermore, once it is clear that a problem has occurred, it may take time to dispatch a service technician, plus time for that technician to travel to the hosting site. Thus, with the exemplary FSP of FIG. 8, two-thirds or more of the end-to-end service time elapses even before the technician begins to diagnose the problem. Collectively, these non-productive activities may represent another potential leverage point.

### Analysis of a Remotely-Detected Off-Site (Remote) FSP

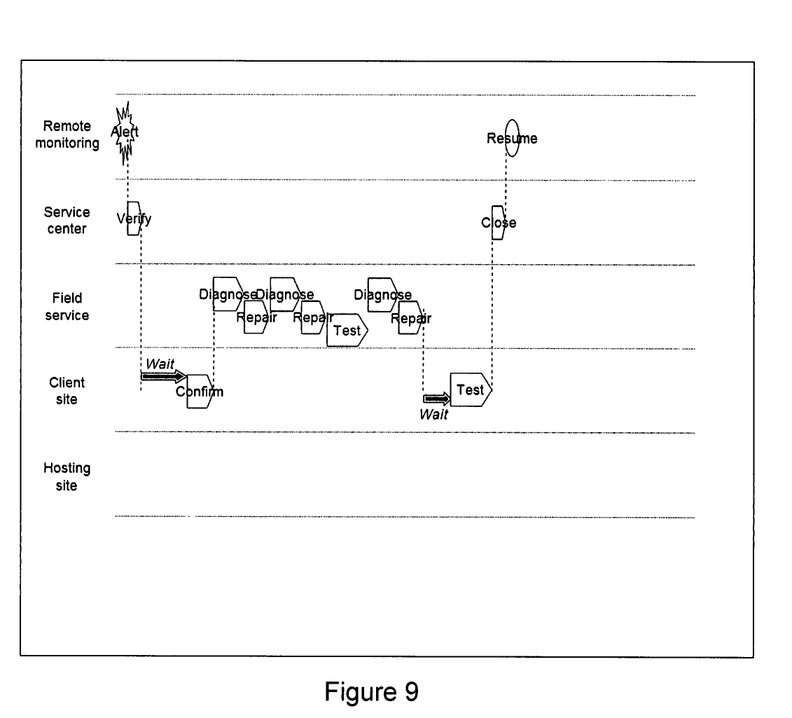

FIG. 9 illustrates a process view output of the process quantification tool 30 for an exemplary FSP, where remote monitoring detects a problem that may be resolved remotely. For example, the problem may be a software problem, rather than a hardware problem, that is amenable to remote resolution. In this exemplary FSP, a service provider (e.g., a technician) may begin work sooner than an on-site FSP (e.g., FIG. 8), because there is no travel time. However, as shown in the process view of FIG. 9, the quantification of the activities of this exemplary instance of an FSP may still indicate potential leverage points. In this example, wait time may not be a major factor, but in situations where clients are dissatisfied with end-to-end service time, the service provider may determine whether client-induced wait time is significant since that may not be a leverage point under the service provider's control.

### Analysis of Asynchronous Activities

In a further aspect of the invention, the invention may be used to quantify and analyze asynchronous activities. In contrast to the previous examples, where the time scale may be a few hours or days, the time scale for this process may typically be some number of years. Complex services can be comprised of many related activities performed over an extended period. Moreover, an activity-level view of those services may not sufficiently show the complexity of the end-to-end process.

According to an aspect of the invention, the process quantification tool 30 may be used to ensure the asynchronous process is working efficiently and properly. That is, rather than improving the process by reducing an end-to-end duration, the present invention may be used to ensure that the right activities are occurring at the necessary times.

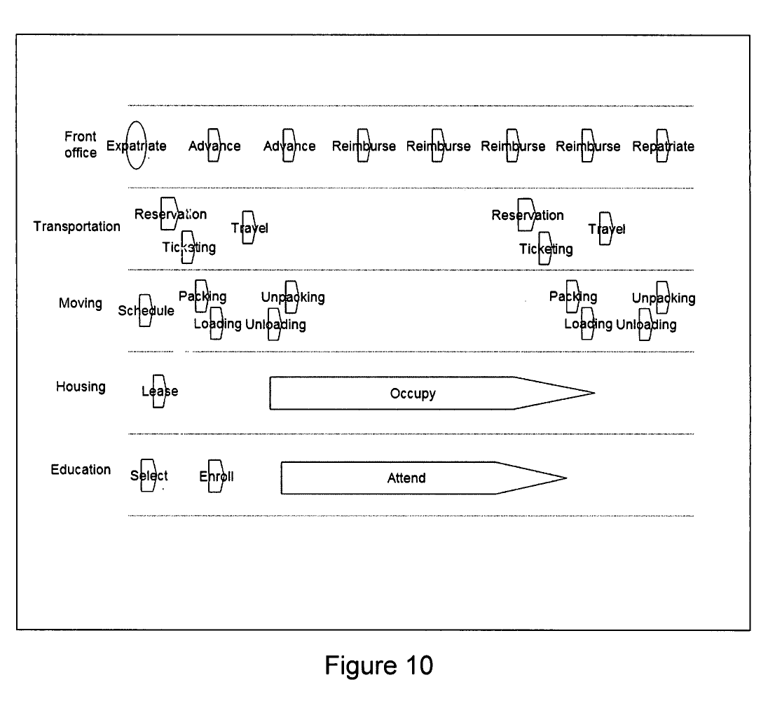

For example, FIG. 10 shows a process view output from the process quantification tool 30 illustrating an exemplary BOP quantification with asynchronous activities. In embodiments, data collection may occur over an extended period of time (e.g., 18-24 months) using the data collection tool 50. Furthermore, the process quantification tool 30 aggregates the collected data in a process record in a central location (e.g., a database contained in storage system 22B). Moreover, the process quantification tool 30 may generate the process view of FIG. 10. In embodiments, the process view may have, e.g., 60-70 records of activities representing an end-to-end process. Furthermore, as shown in the process view of FIG. 10, the horizontal dimension represents time and the vertical dimension represents individual services (or roles) that make up the entire process. Thus, the time and duration of each activity are shown.

In this exemplary BOP, the process itself is relocation services for expatriates. In contrast to the previous examples, where it may be beneficial that each activity follows its predecessors as soon as possible (e.g. a serial process), asynchronous activities may be triggered by events or performed according to a specific schedule. Moreover, time gaps may be acceptable (e.g., not detrimental to the overall process) as long as events occur when those events become necessary. In other words, end-to-end duration may be unimportant, but timeliness of each activity may be critical. For example, housing should be available when movers arrive to unload at the destination.

Additionally, the process view of FIG. 10 shows the activities that may be involved in the exemplary relocation BOP. For example, an “Expatriate” activity may include a service provider initiating the expatriation services. Additionally, an “Advance” activity may include a service provider issuing payment before a third-party incurs expenses. This may include a service provider issuing payment to a third party. This may also include a service provider issuing payment to the party being relocated, so that they may pay the third party at the time of service, rather than waiting to file an expense report later. Moreover, a “Reimburse” activity may include a service provider issuing payment after third-party expense are incurred. Furthermore, a “Repatriate” activity may include a service provider terminating the expatriation services.

As shown in the process view of FIG. 10, under normal circumstances, transportation of family members and moving of household goods occur at the beginning and the end. Housing and education are established at the beginning, then continue for the duration. If, however, an employee is relocated for more than one year, transportation, moving, housing, and education activities may be performed more often than shown in this example.

Additionally, with this type of process, customer satisfaction may be a more important concern. Thus, the data collection tool 30 may provide for input of customer service surveys (e.g., trailer surveys that trail the activity). In the case of relocation services, the “customer” is the employee and their family.

### Analysis of Time Management of Activities

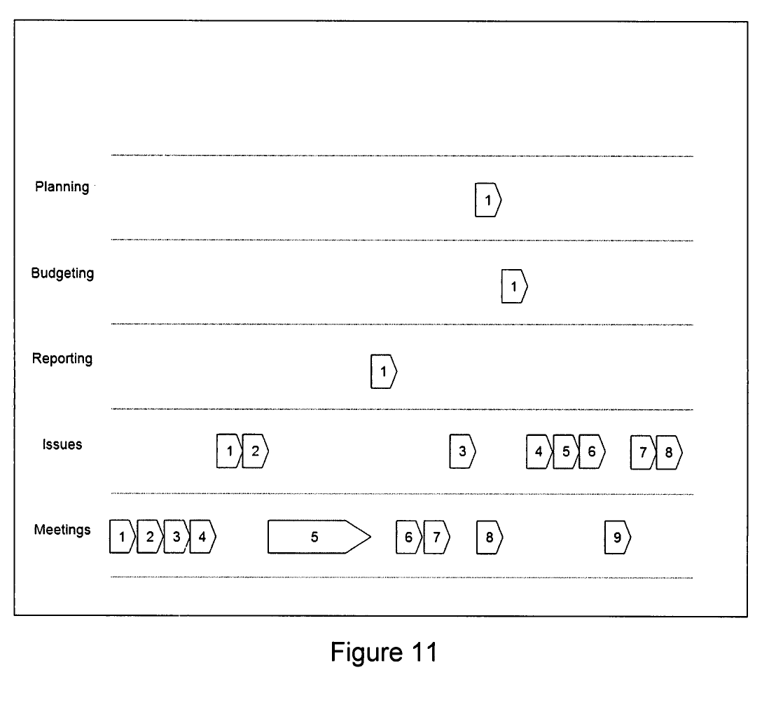

Additionally, the invention may be used to quantify and analyze time management of activities of an employee (e.g., a manager). FIG. 11 illustrates a process view output of the process quantification tool 30 of a study of managerial activities related to BOP and FSP based upon quantifying data collected by at least one data collection tool 50. In this exemplary process, there may only be types of activities (e.g., planning, budgeting, reporting, issues, and meeting), with no standard sequence. The goal of the study may be to determine whether the overall allocation of an employee's (e.g., a manager's) time is appropriate. Similar studies may be performed for quality assurance activities.

As discussed above, a data collection tool 50 may be used to collect quantifying data. In embodiments, the period of data collection utilizing the data collection tool 50, may be varied. That is, data may be collected and analyzed daily, weekly, monthly, etc. For example, for a one-time study, data may be collected for 30-90 days. As a further example, for an ongoing study, data may be collected only during certain periods, e.g., the last week of each month. Moreover, in embodiments, by collecting data daily, the present invention would allow a comparison of, e.g., a manager's activities on a day-by-day basis.

Additionally, in embodiments, the data may be compiled in a variety of ways. For example, data may be collected daily for a period of time (e.g., a year) and then compiled by day of the week. This would allow a quantification and analysis of, e.g., a manager's activities by day of the week. For example, after collecting data for a year, it may be determined that a worker is more efficient on Tuesdays and Wednesdays, but less efficient on Mondays and Thursdays.

Additionally, in embodiments, the efficiencies of multiple workers may be compared to one another. That is, the data collection tool 50 may be used to collect quantifying data reflecting the activities of multiple workers who are performing the same task. Moreover, the process quantification tool 30 may consolidate the quantifying data for an individual worker into a process record and may generate a process view. An analyst may then use the process views for different workers to compare the workers' apportionment of time in performing the same task.

As shown in the process view of FIG. 11, in this exemplary instance, a manager spent the majority of his or her time in meetings or dealing with issues. Relatively little time was spent planning, budgeting, and reporting. If this allocation is typical, the manager may rethink whether all those meetings are necessary and whether all those issues require management attention. For example, perhaps some of those issues may be handled by others who are not managers.

Additionally, the present invention may also be used to study the impact of technology. By implementing aspects of the invention, the process quantification tool 50 may quantify the impact of a given technology on, e.g., time savings or reduced error rates. For example, a user at a computer may be using different systems (e.g., a calculator and a word processor) to solve a problem. A quantification and analysis of the user's actions and methods may determine that the user is not using the technology efficiently. As a further example, a quantification and analysis may determine that a user is not utilizing a frequently asked questions (FAQ) database to efficiently solve a particular problem. Likewise, the process quantification tool 50 may compare full-service and self-service alternatives.

According to a further aspect of the invention, utilizing the output of the process quantification tool 30 and the data collection tool 50, an analyst may answer key research questions and/or identify possible leverage points for process improvement. For example, if capacity management is the goal, the following research questions may be analyzed: where are the bottlenecks? How can those bottlenecks be alleviated? For instance, would delays due to time zone differences between the service provider and recipient be alleviated by relocating resources? If service level attainment is the goal, the following research questions may be analyzed: what are the proximate and root causes of service level misses? For instance, are there problems in training or tooling? If an empirical basis for best practices is the goal, the following research questions may be analyzed: what are the best practices? How were they implemented? Are they really transferable—or only best in a local context?

Moreover, regardless of the goal, the process quantification tool 30 may identify leverage points for process improvement. Leverage points may be places where a modest change in a process, such as automation of a previously manual activity, creates a large change in desirable outcomes. Specifically what causes cases to be rejected by automatic processing and what creates bottlenecks in exception handling? Further, if rework due to errors in, e.g., a BOP is significant, what are the root causes of errors that may eliminate some of that rework? Likewise, if problems are not being resolved on the first attempt to complete, e.g., an FSP, what are the root causes of repeated service calls that may eliminate some of the delay, expense, and dissatisfaction they create.

Additionally, an analyst may drill down from the process record, the process view, or the activity view to the activity records (e.g., the quantifying data collected by, e.g., a data collection tool 50) to view additional information as needed to answer research questions. For example, in embodiments, the aggregated collected data may not identify who (e.g., which technician) collected which data. However, by drilling down to the activity records, an analyst may determine, e.g., which technician collected certain data.

Furthermore, for example, if some service records are outliers (extreme values), an analyst may validate the underlying activity records (and correct if errors are found). Once validated, if some service record are still outliers, the activities that comprise them may yield new insights. For instance, it may do more to narrow the search for trouble by running a specific test early during diagnostic activities in an FSP, rather than later.

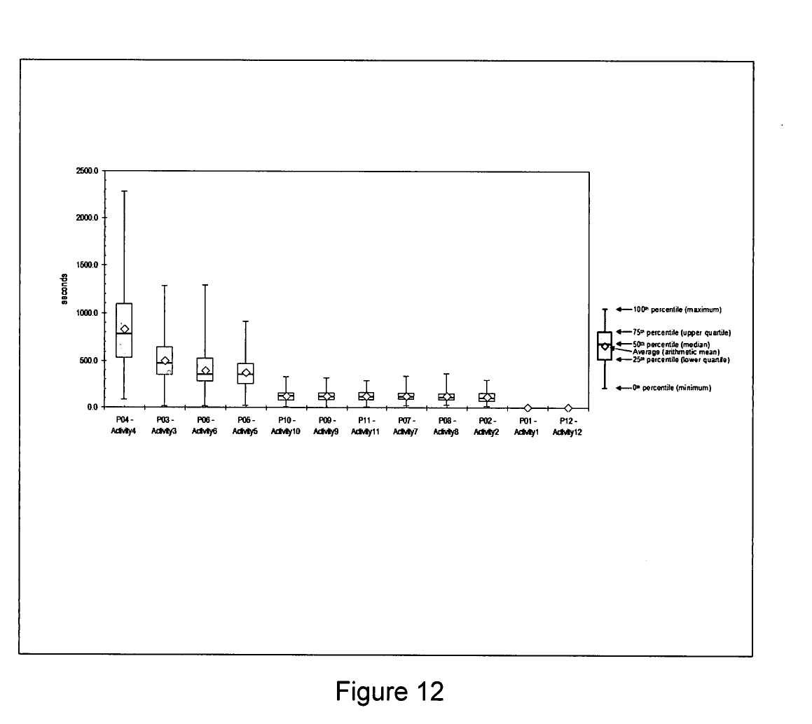

FIG. 12 shows an exemplary output of the process quantification tool 30, in the form of a box-and-whiskers graph, which indicates a quantification of activities comprising a BOP or an FSP that may be used to analyze the BOP or FSP. The box-and-whisker graphic for each activity represents six statistics (0^{th}, 25^{th}, 50^{th}, 75^{th} and 100^{th} percentiles, and the arithmetic mean), as explained in the legend to the chart.

As shown in FIG. 12, the data may be ordered in share of time by each activity, rather than in the order each activity was performed. Moreover, the graph represents data from multiple instances (e.g., for organizations A-Z) of one defined process (e.g., a disk drive replacement). Furthermore, these graphs can be used to compare same processes (e.g., a disk drive replacement) completed using slightly different activities (e.g. picking up the replacement disk drive at parts depot “2” versus parts depot “4”).

As shown in FIG. 12, the pattern of arithmetic means may be typical of a BOP and an FSP. That is, when sorted by average duration, four of twelve activities account for nearly three-fourths of total duration. Thus, in analyzing the quantifying data, an analyst may identify those four activities as potential leverage points, and determine that improving any of the other eight may only have negligible impact.

According to a further aspect of the invention, the box-and-whiskers chart may be used to represent a portion of the activity view. That is, while the activity view was described above as including, e.g., a chart or spreadsheet of activities performed and the time used for each of those activities, the same information may be presented in a box-and-whiskers chart. However, if the box-and-whiskers chart is used to illustrate the activity view for a single instance of a process, the chart may not indicate all of the data represented in FIG. 12.

### Flow Diagram

The steps of the flow diagram described herein may be implemented in the environment of FIG. 1. The flow diagram may equally represent a high-level block diagram of the invention. The steps of the flow diagram may be implemented and executed from either a server, in a client server relationship, or they may run on a user workstation with operative information conveyed to the user workstation. Additionally, the invention can take the form of an entirely hardware embodiment, an entirely software embodiment or an embodiment containing both hardware and software elements. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

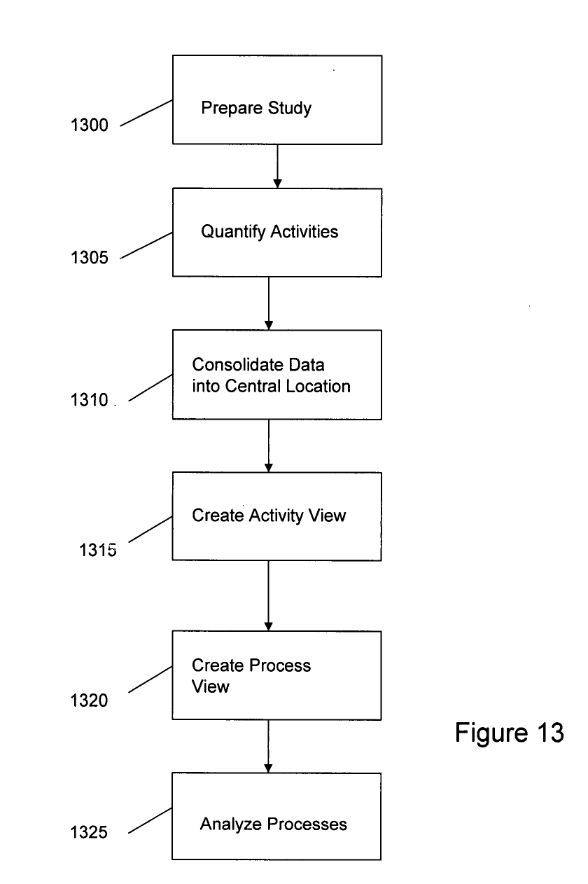

FIG. 13 shows an exemplary flow chart for performing steps of the invention. At step 1300, a study may be prepared by a designer/researcher. In embodiments, the study may be a study of a BOP, an FSP, an asynchronous process, or a time management of activities. As discussed, preparing the study may include determining research questions to be answered, configuring at least one data collection tool 50, defining how the process quantification tool will aggregate data values from activity records into service records, and entering predefined analysis parameters. At step 1305, the activities may be quantified by collecting quantifying data. In embodiments, the activities may be quantified automatically or manually. In embodiments, at least one data collection tool 50 may be used to quantify activities. Moreover, the at least one data collection tool 50 may associate the gathered quantifying data with a particular process using common key identifiers. At step 1310, the process quantification tool 30 may consolidate the collected quantifying data into a process record, e.g., in a database in storage system 22B. The process quantification tool 30 utilizes the common key identifiers to match the collected quantifying data with a process record for the particular process, e.g., a particular BOP or FSP. At step 1315, the process quantification tool 30 generates an activity view of the particular process. At step 1320, the process quantification tool 30 generates a process view of the particular process. At step 1325, an analyst may analyze the particular process. In embodiments, the analyst may use the activity view and the process view to answer the research questions determined at step 1300. Moreover, in embodiments, an analyst may toggle between the activity view and the process view to analyze the process. Additionally, the analyst may drill down from the process records into the activity records to analyze the process.

While the invention has been described in terms of embodiments, those of skill in the art will recognize that the invention can be practiced with modifications and in the spirit and scope of the appended claims.

What is claimed is:

1. A method implemented in a computer infrastructure having computer executable code, comprising:
collecting quantifying data to quantify each activity of a process;
consolidating the quantifying data into a process record; and
creating a process view from the process record, wherein the process view comprises at least an indication of a timing and duration of each activity of the process.

2. The method of claim 1, further comprising determining the quantifying data manually or automatically.

3. The method of claim 1, wherein the quantifying comprises entering the quantifying data into at least one data collection tool.

4. The method of claim 1, wherein the collecting occurs contemporaneously with performance of the each activity.

5. The method of claim 1, wherein the process is one of a back office process (BOP), a field service process (FSP), an asynchronous process, and a time management process.

6. The method of claim 1, wherein the quantifying data comprises at least one of activity classifications, activity descriptors, activity timers, activity sequencing, activity diagnostics, activity resolution and activity results.

7. The method of claim 1, wherein the quantifying data is consolidated into the process record by matching a process record key identifier with an activity key identifier.

8. The method of claim 1, further comprising creating an activity view from the process record, wherein the activity view comprises the quantifying data for each activity of the process.

9. The method of claim 1, further comprising:
preparing for a study of the process by at least one of determining questions to be addressed by the study, configuring at least one data collection tool, and determining aggregation parameters; and
utilizing at least one of the process record, the process view, and an activity view to analyze the process to support at least one of capacity management, process improvement, and service level attainment.

10. The method of claim 1, wherein a service provider at least one of creates, maintains, deploys and supports the computer infrastructure that performs the steps of claim 1.

11. The method of claim 1, wherein steps of claim 1 are provided by a service provider on a subscription, advertising, and/or fee basis.

12. A process quantification tool comprising a computer infrastructure operable to:
consolidate collected activity quantifying data for a process from data sources into a process record in a central location; and
generate a process view of the process from the process record, wherein the process view indicates at least a timing and a duration of each activity of the process.

13. The process quantification tool of claim 12, wherein the process quantification tool matches the activity records of the process with the process record using common key identifiers.

14. The process quantification tool of claim 12, wherein the computer infrastructure is further operable to generate an activity view of the process from the process record, wherein the activity view comprises the activity quantifying data for each activity of the process.

15. The process quantification tool of claim 12, wherein the process view accounts for at least one of process iterations, process non-productive time, process queue time, process wait time and process travel time.

16. The process quantification tool of claim 12, wherein the process comprises one of a back office process, a field service process, an asynchronous process, and a time management process.

17. The process quantification tool of claim 12, wherein the computer infrastructure is further operable to generate a view comprising activity data for separate instances of a same process.

18. The process quantification tool of claim 12, wherein the computer infrastructure is further operable to:
receive collected activity quantifying data from at least one data collection tool, wherein the at least one data collection tool comprises a second computer infrastructure operable to:
start and stop at least one timer contemporaneously with a user, respectively, starting and stopping at least one activity of a process to generate timing data;
collect timing data to determine a duration of the at least one activity of the process; and
collect other quantifying data of the at least one activity of the process.

19. The process quantification tool of claim 18, wherein the second computer infrastructure is further operable to generate a graphical user interface (GUI) comprising:
at least one dropdown list of activity identifiers of activities that may be performed by the user for the process, which allows the user to select predefined activity identifiers or add activity identifiers;
for each activity of the process performed by the user, a timer start/stop mechanism, or a timer start mechanism and a timer stop mechanism to generate the timing data; and
for each activity of the process performed by the user, corresponding data entry fields for containing the timing data and the other quantifying data.

20. A computer program product comprising a computer usable medium having readable program code embodied in the medium, the computer program product includes at least one component to:
collect quantifying data to quantify each activity of a process;
consolidate the quantifying data into a process record; and
create a process view from the process record, wherein the process view comprises at least an indication of a duration of each activity of the process.
